(19) United States
(12) Patent Application Publication
(10) Pub. No.: US 2025/0362860 A1
(43) Pub. Date: Nov. 27, 2025

(54) SYSTEM AND METHOD FOR IMPLEMENTING COLLABORATOR CHANGES TO SHARED CONTENT

(71) Applicant: FIGMA, INC., San Francisco, CA (US)

(72) Inventors: Andrew CHAN, San Francisco, CA (US); Alexander RINGLEIN, New York, NY (US); Michael TURITZIN, San Francisco, CA (US)

(21) Appl. No.: 19/216,559

(22) Filed: May 22, 2025

Related U.S. Application Data
(60) Provisional application No. 63/650,544, filed on May 22, 2024.

(51) Int. Cl. G06F 3/14; G06T 1/60; G06T 3/40; G06T 11/60

(52) U.S. Cl. CPC G06F 3/1462; G06T 1/60; G06T 3/40; G06T 11/60

(57) ABSTRACT

A user device renders content tiles in cache, where the content tiles represent a segment of a shared content provided on a canvas. The user device receives collaborator change data over one or more networks, where the collaborator change data represents a change made to the shared content by a second user device. The user device determines which content tiles in cache are affected by the collaborator change data. For each affected content tile, the user device implements a time-slicing process to render a replacement content tile, and after completing rendering of the replacement tile, the user device updates the cache by replacing the affected content tile with the replacement tile. The user device displays the segment of the shared content using the updated cache.

### CROSS-REFERENCE TO RELATED APPLICATIONS

This application claims priority benefit of United States Provisional Patent Application titled “SYSTEM AND METHOD FOR IMPLEMENTING COLLABORATOR CHANGES TO SHARED CONTENT”, Ser. No. 63/650,544, filed May 22, 2024. The subject matter of this related application is hereby incorporated herein by reference.

### TECHNICAL FIELD

Examples described herein relate to a system and method for implementing collaborator changes to shared content.

### BACKGROUND

Software design tools have many forms and applications. In the realm of application user interfaces, for example, software design tools require designers to blend functional aspects of a program with aesthetics and even legal requirements, resulting in a collection of pages which form the user interface of a software application product. Product designers and developers who collaborate on projects, including product design projects, often find it challenging to track and share product development progress, in addition to other changing objectives and requirements as a product design project evolves. Synchronous meetings can bring myriad cross-functional voices into the design process and help teams develop and refine ideas together. During such live collaborative sessions, designers are looking for ways to ensure their collaborators are focused on the right parts of their work product content and files. They may desire ways to review their designs in a more timely, collaborative and focused manner, with the ability to call their attention to, or direct their members of their collaborative group to, a specific part of workspace files in order to share progress, context and to update project and product requirements as well as instructions related thereto.

### BRIEF DESCRIPTION OF THE DRAWINGS

FIG. 1 illustrates a platform for implementing a collaborative session, according to one or more embodiments.

FIG. 2A illustrates an example method for implementing a collaborator change to a shared content, according to one or more embodiments.

FIG. 2B illustrates an example method 250 for implementing a time-slicing process, according to one or more embodiments.

FIG. 3 illustrates a computer system on which one or more embodiments can be implemented.

FIG. 4 illustrates a user computing device for use with one or more embodiments, as described.

### DETAILED DESCRIPTION

Interactive graphic application platforms currently exist to enable users to simultaneously collaborate on content that is shared amongst the user devices of the collaborators. These platforms enable the users to view and edit shared content on a canvas. Such platforms exist for enabling collaborators to participate on different types of shared content—such as, for example, graphic design, whiteboarding and presentation (e.g., slides) applications.

Examples as described enable users to operate user devices (e.g., desktop computer, workstation, mobile device, etc.) to participate in a collaboration of shared content. Each user device can include an application (e.g., browser or browser-enabled application) to implement a collaborative interactive graphic application platform (“IGAP”) on the respective user device. The IGAP can enable the respective users to collaborate on highly complex graphic designs, where, for example, numerous graphic elements, graphic element attributes and layers are provided. The IGAP enables users to view and edit shared content. Further, changes made by collaborators to the shared content are reflected in real-time on the user devices of the other collaborators.

In context of collaborative platforms such as described with examples, rendering changes to the shared content can be computationally intensive. Not only may the shared content be complex, but different situations or events can make the rendering of shared content particular difficult. For example, user's can perform navigational viewing operations, such as increasing or decreasing magnification levels of the user's scene, panning the canvas or scrolling. As another example, changes made by another collaborator, or multiple other collaborators, must be reflected in real-time (or near real-time) on each user device. Even more difficult is the situation where one user is performing a navigational viewing operation at the same time as when one or multiple other collaborators are making changes to the shared content.

Under pinning the technical challenges, the user devices have hardware restrictions where they each display the shared content by continuously generating frames for a display component (e.g., monitor). Typically, components such as a graphic processing unit generates new frames at 60 or more frames per second. Under prior approaches, the frame rate can impose a limitation, defining the interval under which the IGAP processes renders the shared content. In cases where the graphic content is complex, many collaborators or changes take place, and/or navigational operations are taking place, updating the shared content within a frame interval (e.g., 1/60 seconds) may not be possible, resulting in diminishing of the quality and responsiveness of the shared content on the user device. These types of display performance issues are reflected by, for example, a user device stuttering (e.g., hanging or temporary freezing), lagging, flickering and/or displaying the shared content with less fluidity and responsiveness.

Examples as described improve the ability of user devices to display shared content in a collaborative platform, particularly in context of an interactive graphic application platform, and more specifically, in situations where the rendering processes are most difficult. Such situations include, for example, when a user device is implementing a navigational viewing operation (e.g., increasing magnification or “zooming in”) while at the same time, displaying in real-time changes that are made to the shared content from the user devices of other collaborators (“collaborator changes”). In this way, examples as described provide a technical improvement and effect, by improving the ability of the collaborator devices to reflect real-time changes to shared content, even in otherwise difficult scenarios. The improvements provide the users of a collaborative platform more fluidity, responsiveness and overall display performance, particular in context of collaborative, graphic-intense application services (e.g., graphic design). Moreover, the improvements can be made within a framework of an application (e.g., browser or browser-based application) on which a collaborative graphic application platform is provided.

According to examples, a computer device or system is provided for implementing collaborator changes to shared content. In examples, a user device renders content tiles in cache, where the content tiles represent a segment of a shared content provided on a canvas. The user device receives collaborator change data over one or more networks, where the collaborator change data represents a change made to the shared content by a second user device. The user device determines which content tiles in cache are affected by the collaborator change data. For each affected content tile, the user device implements a time-slicing process to cache-render a replacement content tile, and after completing rendering of the replacement tile, the user device updates the cache by replacing the affected content tiles of an existing scene with the replacement tiles of a new scene. The user device displays the new scene using the updated cache.

In examples, a time-slicing process ensures that the process for rendering individual content tiles in cache is not interrupted or negatively affected by the user device restarting rendering at the start of each frame. The time-slicing process efficiently continues the process for rendering individual content tiles between consecutive frame intervals. Moreover, the time-slicing process is used to render content tiles in cache, and such content tiles are not displayed until the rendering process in cache is complete. This process preserves performance, fluidity and responsiveness in displaying the shared content on a collaborator device, in that the process is not noticeably affected by the GPU of the user device creating a new frame. At the same time, the process does not overly burden the creation of new frames, thereby preserving the performance of the user device.

Still further, examples provide an interactive graphic application platform where different rendering processes and rendering optimizations are used. For example, a user device of a collaborative session can selectively implement a time-slicing process for situations when the additional time needed for implementing the time-slicing process is likely to exceed the frame interval. In other situations, the user device may re-render individual tiles from scratch, or alternatively, re-render changes to the shared content by modifying (e.g., extrapolating) existing content tiles within a frame interval. Additionally, the time-slicing process can be implemented with an allotted time interval (“allotted time-slicing budget”). Thus, examples provide that the rendering process used for individual content tiles can be selectively implemented and/or configured based on the situation or context (e.g., size or complexity of shared content).

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

### System Description

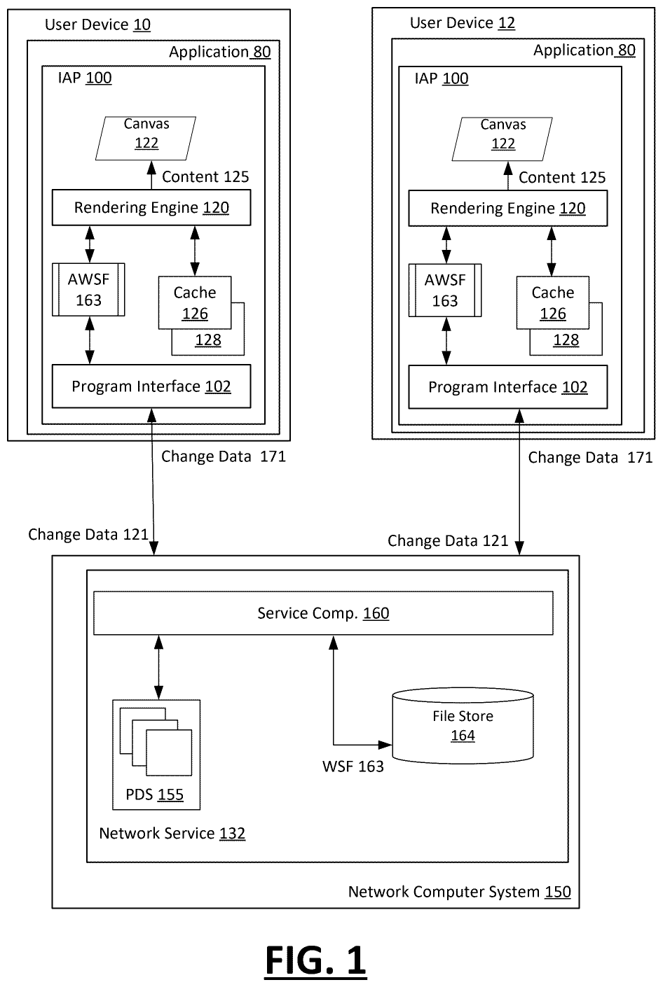

FIG. 1 illustrates a platform for implementing a collaborative session, according to one or more embodiments. A network computing system such as described with an example of FIG. 1 can be implemented using one or more server computing devices which communicate with user computing devices over one or more networks.

In examples, a collaborative platform is implemented by a network computing system 150 that communicates with multiple user devices 10, 12 operated by collaborators of the session. Each user device 10, 12 can execute instructions for implementing an interactive application platform (“IGAP 100”) to enable the participation of a corresponding user in the collaborative session. In examples, the IGAP 100 provides, or otherwise enables a user's computing device to utilize one or more application services, where each application service provides a particular type of application functionality. By way of example, the application service(s) include (i) an interactive graphic application service, to enable users to create and share dynamic and interactive designs, including designs that can be prototyped or imported to a run-time environment, for example in accordance with a run-time simulation engine; (ii) a whiteboarding application service, to enable users to create and share visual content to share ideas with other users; (iii) a code creation application service to enable code creation and representation based on graphical and/or textual input; (iv) a presentation application service to enable users to create and share presentations (e.g., slides); (v) a word processing application service; and/or (vi) an application to enable users to create and share one or more types of structured data sets (e.g., database, spreadsheet, table, etc.). Accordingly, each application service can provide functionality and configurations that are separate from the other application service(s).

According to examples, each user of computing device 10, 12 operates web-based application 80 to access a network site, where programmatic resources are retrieved and executed to implement the IGAP 100. The web-based application 80 can execute scripts, code and/or other logic (the “programmatic components”) to implement functionality of one or more application services provided by the IGAP 100. In examples, the web-based application 80 can correspond to a commercially available browser, such as GOOGLE CHROME (developed by GOOGLE, INC.), SAFARI (developed by APPLE, INC.), and INTERNET EXPLORER (developed by the MICROSOFT CORPORATION). In variations, the web-based application can correspond to a dedicated application, such as a web-based application, for communicating with a network service 132 provided through the network computer system 150. In such examples, the processes of the IGAP 100 can be implemented as scripts and/or other embedded code which web-based application 80 downloads from a network site. For example, the web-based application 80 can execute code that is embedded within a webpage to implement processes of the IGAP 100. The web-based application 80 can also execute the scripts to retrieve other scripts and programmatic resources (e.g., libraries) from the network site and/or other local or remote locations. By way of example, the web-based application 80 may execute JAVASCRIPT embedded in an HTML resource (e.g., web-page structured in accordance with HTML 3.0 or other versions, as provided under standards published by W3C or WHATWG consortiums). In some examples, the rendering engine 120 may utilize graphics processing unit (GPU) accelerated logic, such as provided through WebGL (Web Graphics Library) programs which execute Graphics Library Shader Language (GLSL) programs that execute on GPUs.

The IGAP 100 can be implemented on each collaborator device 10, 12 as a web-based application 80 that communicates with one or more remote computers (e.g., server used for a network service) to executes processes of the IGAP 100. The web-based application 80 retrieves some or all of the programmatic resources for implementing the IGAP 100 from a network site. The web-based application 80 may also access various types of data sets from the network service 132 and/or other remote locations in providing the IGAP 100 and associated functionality.

On each user device, 10, 12, the IGAP 100 includes a program interface 102, an input interface 118 and a rendering engine 120. The program interface 102 can include one or more processes which execute to access and retrieve programmatic resources from local and/or remote sources. The retrieved resources can include a shared workspace file 163 (retrieved from a network data store 164) that includes data sets from which shared content is rendered by each user device 10, 12 that participates in a collaborative session. In a collaborative session, each collaborator operates a corresponding collaborator device 10, 12 to access the shared workspace file 163. Each user device 10, 12 can maintain a local copy of a shared workspace file, where each local version or copy of the workspace file is maintained in synch (or continuously synchronized) though the network service 132. As collaborators, each user can edit and update the shared workspace file, such that changes made by one collaborator are propagated or otherwise synchronized in real-time (or near real-time) to other users. In this way, each collaborator views and edits a fully updated and current version of the workspace file, with changes from other users being present. In some examples, the type of workspace file can include a graphic file, such as for a graphic design file for a graphic design application or for a whiteboarding application. The shared workspace file 163 can represent the shared content in the form of a hierarchical nodal representation, with individual content elements (e.g., frame for design file, widget for whiteboarding application, slide or slide element for presentation application, etc.) being defined as nodes with corresponding attributes. As an addition or variation, the hierarchical relationship of the shared content can be implemented as a document object model (DOM) type representation (e.g., with individual content elements being represented as a node of the DOM).

As used herein, term “shared workspace file” can include multiple local copies of the workspace file which are synchronized via, for example, processes running on user devices 10, 12 of the collaborative session and/or network service 132.

On each user device 10, 12, the program interface 102 can generate, for example, a canvas 122, using programmatic resources which are associated with web-based application 80 (e.g., HTML 3.0 canvas). As an addition or variation, the program interface 102 can trigger or otherwise cause the canvas 122 to be generated using programmatic resources and data sets (e.g., canvas parameters) which are retrieved from local (e.g., memory) or remote sources (e.g., from network service). The program interface 102 may also retrieve programmatic resources that include an application framework for use with canvas 122. The application framework can include data sets which define or configure, for example, a set of interactive tools that integrate with the canvas 122. In examples, the set of interactive tools can include graphic tools that enable a user to create one or multiple types of graphical content (e.g., graphic design interface and/or whiteboard design or content, etc.).

The IGAP 100, as implemented by the collaborator devices 10, 12, provide the input interface 118 as a functional layer that is integrated with the canvas 122 to detect and interpret user input. The input interface 118 can, for example, use a reference of the canvas 122 to identify a screen location of a user input (e.g., ‘click’). Additionally, the input interface 118 can interpret an input action of the user based on the location of the detected input (e.g., whether the position of the input indicates selection of a tool, an object rendered on the canvas, or region of the canvas), the frequency of the detected input in a given time period (e.g., double-click), and/or the start and end position of an input or series of inputs (e.g., start and end position of a click and drag), as well as various other input types which the user can specify (e.g., right-click, screen-tap, etc.) through one or more input devices. In this manner, the input interface 118 can interpret, for example, a series of inputs as a design tool selection (e.g., shape selection based on location of input), as well as inputs to define attributes (e.g., dimensions) of a selected shape. Additionally, in variations, the input interface 118 can receive input for performing navigation operations with respect to the canvas 122. For example, the users of the collaborator devices 10, 12 can interact with the input interface 118 to increase or decrease the magnification level (also referred as zooming in or zooming out) of the viewport (or display region), to pan and/or scroll.

In an example of FIG. 1, a collaborative platform is implemented by the network computing system 150, which communicates with multiple user computing devices 10, 12 over one or more networks (e.g., World Wide Web or other cloud computing networked computer system) to implement the IGAP 100 on each computing device. The network computer system 150 can include a service component 160 to implement the network service 132 and enable the collaborative session. The service component 160 can communicate a copy of the shared workspace file 163 to each user computing device 10, 12, such that the computing devices 10, 12 can utilize the workspace file 163 at the same time to render the workspace file. Additionally, the service component 160 can also maintain a network-side version of the workspace 163, which can be maintained in a file repository 164. Further, in some examples, the network service 132 can be implemented in part by instruction sets 155 stored on the network system 150 and provided to the user devices 10, 12 during sessions (e.g., collaborative sessions).

The user computing devices 10, 12 can be operated by users that collaborate to create and/or update the workspace file 163. Each collaborator device 10, 12 can access the same set of active workspace files 163, with the respective program interface 102 of the IGAP 100 establish a corresponding communication channel (e.g., web socket connection) with the service component 160. The IGAP 100 can be implemented to enable each computing device 10, 12 to access and update the active workspace files 163 by, for example, making a local copy of the workspace files 163, and synchronizing the change made to the workspace file 163 with the network computing system 150, while receiving from the network computing system 150 changes made to the workspace file 163 by the other computing devices 10, 12 of the shared session. Each user device 10, 12 uses the shared workspace file 163 to generate the shared content 123 for the collaborative session.

The network computing system 150 can implement operations to continuously synchronize the workspace files 163 on each of the user computing devices 10, 12. The user of computing devices 10, 12 can make a change to the respective workspace file 163, rendered as content 123, and the respective rendering engine 120 can implement an update that is reflected by change data 121 to the local copy of the workspace file 163. On each user device 10, 12, the change data 121 can be communicated to the network computer system 150. The network computer system 150 can stream change data 171 (which can correspond to or include change data 121 received from the user device 10) to the computing device 12, to cause the corresponding IGAP 100 to update the workspace file as rendered on the other device. Each user device 10, 12 can also update the local copy of the workspace file using the remotely generated change data 171, as communicated from the network computer system 13. On each user device 10, 12, the rendering engine 120 updates the shared content 123 of the collaborative session accordingly.

### Rendering Shared Content

On each user device 10, 12, the canvas 122 is associated with a cache 126. The content cache 126 can maintain content data in units referred to as ‘tiles’. Each content tile can have a defined size (256×256 pixels). The rendering engine 120 can render shared content of a workspace file by rendering a segment of the shared content that coincides with the current viewport on the respective user device 10, 12. The rendering engine 120 can implement a process where cached tiles are copied straight to their on-screen positions. For example, on a given user device 10, 12, the rendering process can draw cached tiles to the screen in a single draw call.

In some examples, the IGAP 100 can utilize multiple caches 126, 128 to render the shared content. A primary or main cache 126 can store content tiles that correspond to shared content that is presently rendered. The multiple caches 126, 128 can be physically or logically separated. A secondary cache 128 can render content tiles that are in the process of being cache rendered. In examples, when a collaborator change to the shared content is detected, the affected content tiles of the main cache are identified. The rendering engine 120 can also create replacement content tiles in the secondary cache 128. When all of the replacement tiles for the detected change are cache-rendered in the secondary cache 128, the rendering engine 120 swaps the newly created replacement tiles for a new scene that are stored in the secondary cache 128, in place of affected tiles of the existing scene that are stored in the primary cache 126.

In some examples, the canvas 122 is limitless in size. To manage the size of the primary content cache 126, the rendering engine 120 can implement an eviction policy to selectively evict tiles of the existing scene. For example, a least recently used eviction policy can be utilized to select which tiles to evict from the primary content cache 126. Further, empty portions of the canvas 122 (or tiles) are not cached.

A magnification operation (zooming in and zooming out) changes the magnification level of a content rendering on the user devices 10, 12. In examples, the rendering engine 120 can also implement processes to manage tile caching while different types of navigational viewing operations (e.g., panning, increasing magnification, decreasing magnification, etc.) are being performed. In examples, the primary content cache 126 stores content tiles of an existing scene at multiple magnification levels simultaneously, relative to a current magnification level. For example, the content of the viewport (and adjacent segments of the canvas) can be stored by different sets of content tiles, with each set of content tile reflecting a corresponding discrete magnification level. The rendering engine 120 can determine which segments of the canvas should include content tiles in the primary content cache 126, based on, for example, the user's viewport. As each content tile has a fixed resolution, a content tile at a particular magnification level may correspond to four content tiles at the next magnification level.

The user can provide input to change a magnification level of the viewport, by, for example, zooming in on a segment of the rendered content. The rendering engine 120 can maintain at least one set of content tiles in the primary content cache 126 that most closely match to the magnification level of the viewport. The rendering engine 120 prioritizes rendering in the primary content cache 126 the content tiles that most closely match the current magnification level of the viewport. Further, the rendering engine 120 can prioritize rendering, in the primary content cache 126, the content tiles for magnification levels that are lower than the current level. Thus, the rendering engine 120 can prioritize rendering (or eagerly render) in the primary content cache 126 content tiles for segments of interest (e.g., current viewport) based on the current magnification level of the viewport. When the user rapidly increases the magnification level, if content tiles cannot be rendered and cached in time, the content tiles at the existing magnification level can be scaled up. While this may have an effect of blurriness, the effects are temporary and not readily noticeable to the human eye.

### Time-Slicing

In examples, the rendering engine 120 implements a time slicing process to render content tiles in the primary and/or secondary cache 126, 128. Examples recognize that content tiles can be arbitrarily complex, such that rendering the content tile can take longer than the time allotted for a frame (e.g., 60 fps). To avoid dropping frames or disruption, the rendering engine 120 designates a time budget per frame for rendering the content tile in the primary and/or secondary cache 126 (e.g., 60% to 80% of a frame interval). When content files are being rendered in the primary and/or secondary cache 126, 128, the rendering engine 120 can make periodic or timely checks on a time budget, meaning a remainder of time remaining in the frame interval. If the time budget is exceeded while the content tile is being rendered, the rendering engine 120 records the point in the rendering process that has been completed, and pauses rendering the content tile for the remainder of the frame interval. At the start of the next frame interval, the rendering process for the content is re-started, from the point where the rendering process was paused during the prior frame interval.

Among other processes, time-slicing enables the rendering process to generate a command stream for the GPU of the respective user device 10, 12. By facilitating the use of the GPU, the IGAP 100 can utilize a browser-based application programming interface (API) to leverage the GPU of the user device 10, 12, to enhance rendering operations on the respective user device.

The rendering engine 120 can utilize the time-slicing process to render additional or new content tiles while, for example, increase/decrease magnification operations are being performed (e.g., user zooming in or zooming out).

### Changes to Content Rendering

When a user of a first user device 10, 12 makes change the workspace file, the changes can be visually reflected in the rendering of the content on one or more user devices 10, 12 of other users of the collaborative session. In examples, a user of a first user device 10 can interact with the input interface 118 of the IGAP 100 to make changes to a local workspace file 163. The resulting changes to the workspace file 163 can be rendered on the first user device 10 synchronously.

Once a user makes a change to their local workspace file 163, the network computer system 150 can communicate with the IGAP 100 to synchronize with the network-side workspace file 163. In turn, the, the network computer system 150 can trigger other user devices 10, 12 to synchronize the change made on the first user device 10 to the workspace file 163 of the other user devices 10, 12, causing the rendered content on the respective user devices 10, 12 to reflect the change in the first user device 10, 12. This process can be repeated when inputs are received from any of the user devices 10, 12. In a session where there are many collaborators, the tens, hundreds, thousands or more of edits can be recorded to the shared workspace file 163 in a relatively small time interval (e.g., hour).

Further, individual collaborators often have the need to perform navigation viewing operations while changes are being made to the workspace file 163 by other collaborators. For example, a user may view and edit the rendered content at different levels of granularity—meaning the collaborator may have the need to navigate about the canvas (i.e., pan/zoom-in or -out). Given the frequency in the changes made to the shared workspace file 163, it is often the case that users are navigating about the canvas while changes are being made to the shared workspace file 163 that is actively rendered on their respective user devices 10, 12.

Accordingly, as described with other examples, network computer system 150 can trigger, direct or otherwise cause a synchronization process to determine a change to the local workspace file 163 on a first user device 10, and then trigger, direct or otherwise cause the second user device 12 to implement the change to its local workspace file 163. The second user device 12 communicates with the network computer system 150 to implement the change to its local version of the workspace file 163. If the second user device 12 is in the process of performing a navigational viewing operation (e.g., panning about the canvas, zooming-in, zooming-out), and the change to the workspace file 163 affects a portion of the canvas 122 that is being rendered on the second user device 12, the second user device 12 can implement a variation of a time-slicing process to render the content tiles in cache 126 while the navigational viewing operation is ongoing.

In such case, the rendering engine 120 of the second user device 12 implements a process for enabling concurrent canvas navigation and collaborative-change rendering of shared content. In implementing the process, the IGAP 100 communicates with the network computer system 150 to synchronize the local copy of the shared workspace file 163, so as to reflect the collaborator change by the user of the first user device 10. The rendering engine 120 determines which content tiles of the current rendering are affected by the collaborator change to the shared workspace file 163. As the primary and/or secondary content cache 126, 128 can maintain multiple sets of content tiles for different magnification levels of rendering, the identification of affected content tiles can be made for each set of content tiles (or for different levels of magnification).

In examples, the rendering engine 120 implements a variation of a time-slicing process to re-render each affected content tile using the updated local copy of the workspace file 163. For each content tile, the rendering engine 120 implements a series of operations for re-rendering that content file during an allocated time interval, coinciding with a pre-determined portion of the frame interval (e.g., 1/60 seconds). Upon the rendering engine reaching the allocated time interval, the rendering engine 120 records a marker that reflects the operation(s) that were completed before expiration of the allocated time interval. The rendering engine 120 waits for the start of the next frame interval, and then continues the series of operations from the point in the prior interval where the operations were paused. This process can continue for as many frames as required to render replacement content tiles in the secondary content cache 128, to replace affected content tiles in the primary content cache 126.

Once the rendering of the content tiles for a new scene (reflecting a collaborator change) in the secondary content cache 128 is complete, the newly rendered content tile is swapped with the corresponding content tiles of the existing scene that are stored in the primary content cache 126. The rendering engine 126 can then draw from the content cache 126 to update the content displayed on the user device 12. Thus, the existing content tiles, representing the shared workspace file 163 without the change of the first user device 12, are not evicted from the content cache 126 until all of the new content tiles that reflect the collaborator change is completed. By delaying eviction of the existing content tiles from the primary content cache 126, the transition to rendering the new content tile is more fluid.

As described with examples, the rendering engine 120 can make a determination as to which content tiles of the existing scene to replace to reflect a change to the shared content. Further, in examples, multiple sets of replacement tiles can be generated to reflect the new scene (post change) for a portion of the shared content that is displayed in the viewport of the user device 10, 12. For example, when a collaborator change to the shared content is detected, the rendering engine 120 determines, for each magnification level of the existing scene, which content tiles are affected. Further, the determination can include determining, at each magnification level, which content tiles are needed (post change) to render the replacement scene at the same or better level of blurriness. For example, a collaborator change that affects a single content tile at current magnification level can affect 4 content tiles rendered at the next magnification level. Thus, for each content tile affected at a given magnification level, the rendering engine 120 can identify additional content tiles at each level of increased magnification that is cached.

In examples, the rendering engine 120 can selectively implement time-slicing when performing different sub-processes for rendering content tiles of the existing scene and/or new scenes. For example, the rendering engine 120 can implement time-slicing processes when performing antialiasing and filtering operations in the course of rendering content tiles in the cache(s) 126, 128. Further, the rendering engine 120 can vary the allotted time-slicing budget based on factors such as the type of process being performed, the load of the GPU (e.g., the number of rendering processes being implemented), the complexity and size of the rendered content tiles, and various other factors. The allotted-time slicing budget can be varied within the frame interval, and/or the frame interval can be varied as necessary.

Additionally, in examples, the rendering engine 120 adjusts the allotted time-slicing budget on-the-fly in response to the occurrence of certain events. For example, when rendering replacement tiles for a collaborator change, the allotted time-slicing budget can vary based on additional factors. If the user performs certain navigational viewing operations such as panning or zooming, the rendering engine 120 renders in the primary cache 126 additional content tiles for the existing scene (pre-change from collaborator). If additional content tiles are needed for the existing scene, the rendering engine 120 may prioritize the rendering of the additional content tiles in the main cache 126 (for existing scene) over rendering replacement tiles for the new scene (reflecting the collaborator's change). In such case, the rendering engine 120 can interrupt or truncate the allotted time-slicing budget for performing rendering operations for the replacement tiles of the new scene (post collaborator change). For example, the rendering engine 120 can prematurely pause the rendering process of the replacement tiles during the current frame interval, and then use the remainder of the time-slicing budget to perform rendering operations for the additional content tiles of the existing scene. During the next frame, the rendering engine 120 can continue to prioritize rendering additional content tiles for the existing scene. Alternatively, the rendering engine 120 can portion the time-slicing budget of the next frame between the existing scene (e.g., rendering additional content tiles in the primary cache 126) and the new scene (e.g., rendering replacement tiles in the secondary cache 128 to reflect collaborator changes). In this way, examples provide that the rendering engine 120 can selectively prioritize rendering additional content tiles for the existing scene over rendering replacement tiles for the new scene. Further, the rendering process for rendering additional content tiles of the existing scene can also be implemented through a time-slicing process that extends across multiple frame intervals.

Still further, the rendering engine 120 can selectively implement tolerances with the allotted time slicing budgets for different processes. For example, the rendering engine 120 can include logic to selectively extend the time-slicing budget for a process that is in progress, based on the process being performed, the length of time required to perform the process and/or other factors. The time-slicing budget can be extended within the frame interval, as well as by extending the frame interval by a designated amount (e.g., by 10%).

### Methodology

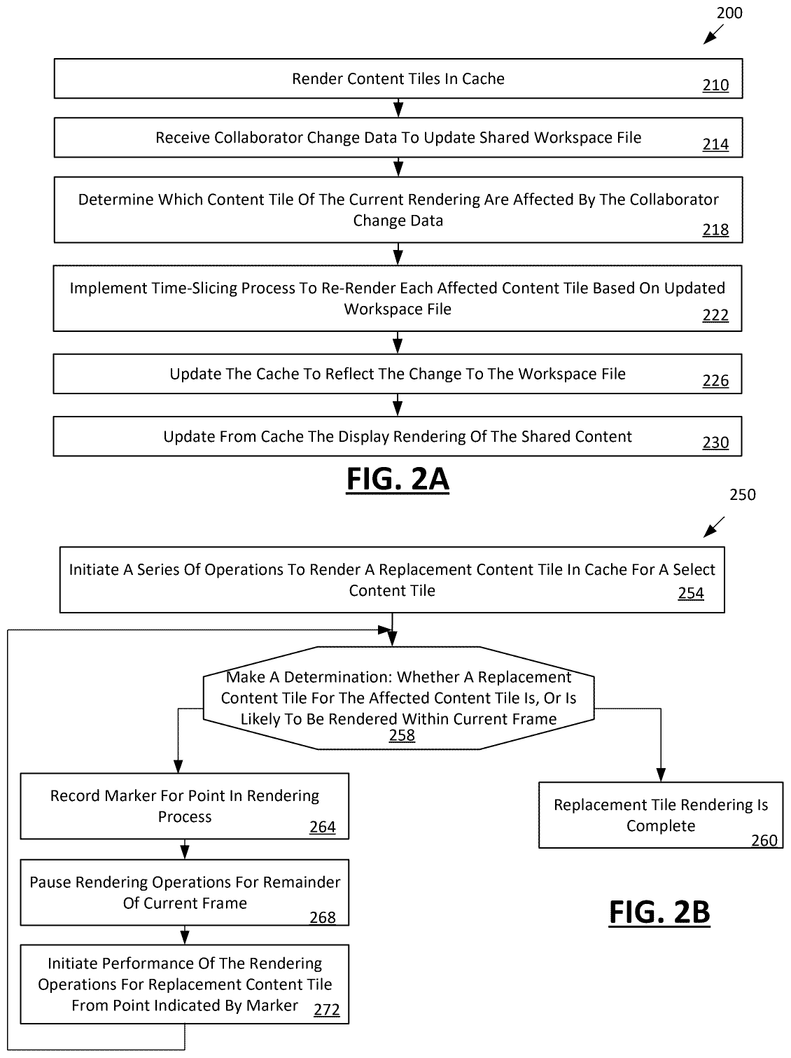

FIG. 2A illustrates an example method for implementing a collaborator change to a shared content, according to one or more embodiments. A method such as described with an example of FIG. 2A can be implemented using, for example, an application on which a collaborative application platform is implemented. Accordingly, reference is made to elements of FIG. 1 for purpose of illustrating components and functionality that are suitable for implementing a step or sub-step being described.

In step 210, the rendering engine 120 of the IGAP 100 can execute on the second user device 12 to render content tiles in cache 126, where the content tiles represent a segment of the canvas 122 that is of interest to the user (e.g., displayed in the viewport) at the particular time. Multiple sets of content tiles can be stored in the cache, with each set corresponding to a magnification level. As described with some examples, multiple sets of content tiles can be stored in a primary cache 126, reflecting different magnification levels of an existing scene of the shared content that is displayed on the user device 12.

In step 214, the user device 12 receives collaborator change data to update the local copy of the shared workspace file 163. The collaborator change data can be received while the second user device 12 is performing a navigational viewing operation. For example, the second user device 12 can receive collaborator change data, corresponding to an edit made on the first user device 10 to the workspace file, while the second user device 12 is performing an operation to increase the magnification level of the shared content.

In step 218, the second user device 12 determines which content tiles of the current rendering are affected by the collaborator change data, representing the collaborator's change to the shared workspace file 163. As described with other examples, the rendering engine 120 can identify multiple sets of affected content tiles, with each set of affected content tiles being for a different magnification level.

In step 222, the second user device 12 implements a time-slicing process to re-render each affected content tile based on the updated workspace file 163. As the complexity of content tiles can vary greatly, the amount of time needed to re-render the content tile can be an unknown. For each content tile, the rendering engine 120 can implement a series of operations to re-render the content tile during an allocated time interval, coinciding with a pre-determined portion of the frame interval (e.g., 1/60 seconds). Upon the rendering engine reaching the allocated time interval, the rendering engine 120 records a marker that reflects the operation(s) that were completed before expiration of the allocated time interval. The rendering engine 120 waits for the start of the next frame interval, and then continues the series of operations from the point indicated by the marker, coinciding with the point in the prior interval where the operations were paused. This process can continue for as many frames as required to cache-render the content tiles. In examples, the IGAP 100 utilizes a secondary cache 128 to re-render the affected tiles for a new scene (with collaborator change), until the content tiles for the new scene are used to replace the affected content tiles from the primary cache 126.

In step 226, the second user device 12 updates the cache to reflect the change to the workspace file 163. In examples, the rendering engine 120 exchanges the affected content tiles of the existing scene for there-rendered content tiles of the new scene. This can include evicting the affected content tiles of the existing scene (without the collaborator change) from the primary cache 126, and copying replacement tiles of the new scene to the secondary cache 128. Further, in examples, the exchange of the replacement content tiles in place of the existing content tiles can happen at one time, meaning the replacement tiles are not swapped in until all of the replacement tiles are re-rendered. In this way, all of the existing content tiles of the affected scene are evicted from the primary cache 126 at one time, coinciding with all of the replacement tiles for the new scene being made available for rendering on the display. The eviction of the existing content tiles (reflecting the shared workspace data 163 without the recent collaborator change) may be delayed until re-rendering of the content tiles reflecting the change to the workspace file 163 is complete. In variations, after expiration of each frame interval, each content tile that is re-rendered in that time interval is swapped with the corresponding set of tiles in the content cache. As another variation, the swapping of content tiles can be performed individually as re-rending of individual content tiles is completed. When a content tile is swapped, the existing content tile is evicted from the cache 126, in place of the new content tile.

In step 230, the second user device 12 updates from the cache the display rendering of the shared content. In examples, the rendering engine 120 of the second user device 12 can draw from the updated primary content cache 126 to update the content rendered to the user of the user device 12.

FIG. 2B illustrates an example method 250 for implementing a time-slicing process, according to one or more embodiments. In examples, method 250 may coincide with step 222 of FIG. 2A. The method 250 can be implemented using, for example, the IGAP 100, as described with an example of FIG. 1. Accordingly, in describing examples of FIG. 2B, reference is made to elements of FIG. 1 for purpose of illustrating a step or sub-step being described.

Method 250 includes, in step 254, the IGAP 100 initiates, during a rendering time interval for a current frame interval, a series of operations to cache-render replacement content tiles for select existing content tile. The select existing content tile can correspond to, for example, a content tile that is affected by a collaborator input.

In examples, a current frame interval represents a time interval for the user device 10, 12 to create a single frame. For example, the user device 10, 12 may operate at 60 fps (frames per second), in which case the frame interval is 1/60th of a second. A rendering time interval (or the allotted time-slicing budget) can be predetermined to be a portion of a single frame interval. For example, the rendering time interval may be set to a portion (e.g., 40-90%) of the single frame interval (e.g., 1/60 second).

Further, method 250 includes, in step 258, the IGAP 100 making a determination, for each affected content tile (resulting from collaborator change), as to whether the replacement content tile for the affected content tile is, or is likely to be rendered within the rendering time interval of a current frame interval. If the determination is that the replacement content tile is, or likely will be complete, then in step 260, the replacement content tile is rendered in cache and the method ends. A replacement content tile can vary in complexity, meaning the time required to render content files can extend beyond a frame interval, and the time required for rendering replacement tiles can vary based in part on the complexity of the content being rendered. In some examples, the IGAP 100 can determine whether the rendering of the replacement content tile is complete upon expiration of the rendering time interval. In variations, at a time just prior to the end of the rendering time interval (e.g., within X milliseconds), the IGAP 100 can calculate an amount of the replacement content tile that has not been rendered. If the amount exceeds a predetermined threshold, the IGAP 100 makes the determination that the replacement content tile cannot, or likely will not, be rendered in the allotted time.

In response to making the determination that rendering the replacement content tile cannot be completed in the allotted time slicing budget, the IGAP 100 time slices a remainder of the series of operations for rendering the replacement content tile. The time slicing includes, in step 264, the IGAP 100 recording a marker that identifies a point in the rendering process which has not been completed (or alternatively, which has been completed). The time slicing further includes, in step 268, the IGAP 100 pausing the rendering operations for the remainder of the current frame interval.

In step 272, during a following frame interval, the IGAP 100 initiates performance of the rendering operations for the replacement content tile from a point indicated by the marker. Following step 272, the method returns to step 258, and repeats for the remainder portion of the replacement content tile.

### Network Computer System

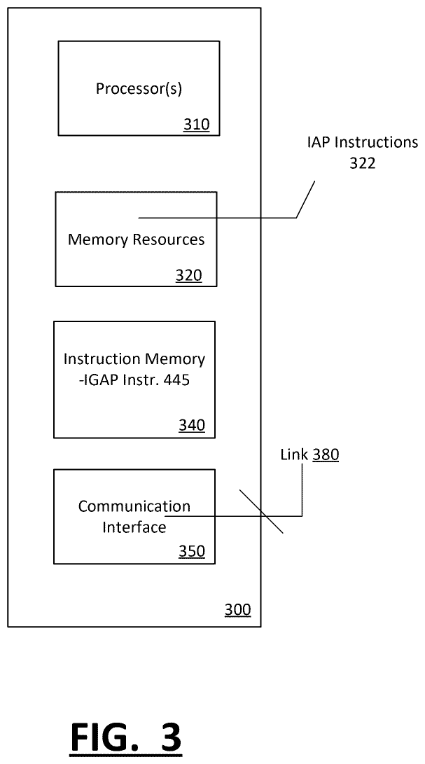

FIG. 3 illustrates a computer system on which one or more embodiments can be implemented. A computer system 300 can be implemented on, for example, a server or combination of servers. For example, the computer system 300 may be implemented as the network computing system 150 of FIG. 1.

In one implementation, the computer system 300 includes processing resources 310, memory resources 320 (e.g., read-only memory (ROM) or random-access memory (RAM)), one or more instruction memory resources 340, and a communication interface 330. The computer system 300 includes at least one processor 310 for processing information stored with the memory resources 320, such as provided by a random-access memory (RAM) or other dynamic storage device, for storing information and instructions which are executable by the processor 310. The memory resources 320 may also be used to store temporary variables or other intermediate information during execution of instructions to be executed by the processor 310.

The communication interface 330 enables the computer system 300 to communicate with one or more user computing devices, over one or more networks (e.g., cellular network) through use of the network link 380 (wireless or a wire). Using the network link 380, the computer system 300 can communicate with one or more computing devices, specialized devices and modules, and/or one or more servers.

In examples, the processor 310 may execute service instructions 322, stored with the memory resources 320, in order to enable the network computing system to implement a network service of and operate as the network computing system 150 in examples described with FIG. 1.

The computer system 300 may also include additional memory resources (“instruction memory 340”) for storing executable instruction sets (“IGAP instructions 322”) which are embedded with web-pages and other web resources, to enable user computing devices to implement functionality such as described with the IGAP 100. In examples, the computer system 300 can communicate the IGAP instructions 322 to computing devices of collaborators during a collaboration session, to enable each of the user devices 10, 12 to implement the IGAP 100 and functionality described with examples.

As such, examples described herein are related to the use of the computer system 300 for implementing the techniques described herein. According to an aspect, techniques are performed by the computer system 300 in response to the processor 310 executing one or more sequences of one or more instructions contained in the memory 320. Such instructions may be read into the memory 320 from another machine-readable medium. Execution of the sequences of instructions contained in the memory 320 causes the processor 310 to perform the process steps described herein. In alternative implementations, hard-wired circuitry may be used in place of or in combination with software instructions to implement examples described herein. Thus, the examples described are not limited to any specific combination of hardware circuitry and software.

### User Computing Device

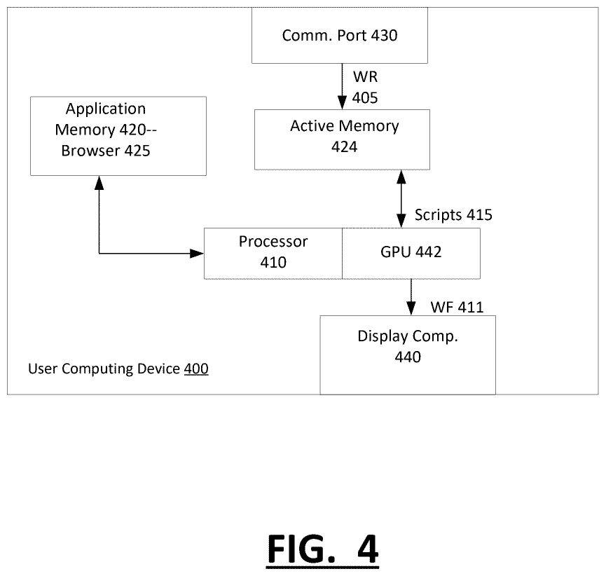

FIG. 4 illustrates a user computing device for use with one or more examples, as described. In examples, a user computing device 400 can correspond to, for example, a work station, a desktop computer, a laptop or other computer system having graphics processing capabilities that are suitable for enabling renderings of design interfaces and graphic design work. In variations, the user computing device 400 can correspond to a mobile computing device, such as a smartphone, tablet computer, laptop computer, VR or AR headset device, and the like.

In examples, the computing device 400 includes a central or main processor 410, a graphics processing unit 412, memory resources 420, and one or more communication ports 430. The computing device 400 can use the main processor 410 and the memory resources 420 to store and launch a browser 423 or other web-based application. A user can operate the browser 423 to access a network site of the network service 132, using the communication port 430, where one or more web pages or other resources 403 for the network service 132 can be downloaded. The web resources 303 can be stored in the active memory 424 (cache).

As described by various examples, the processor 410 can detect and execute scripts and other logic which are embedded in the web resource in order to implement the IGAP 100. In some of the examples, some of the scripts 413 which are embedded with the web resources 403 can include GPU accelerated logic that is executed directly by the GPU 412. The main processor 410 and the GPU can combine to render a workspace file 411 on a display component 440. The rendered design interface can include web content from the browser 423, as well as design interface content and functional elements generated by scripts and other logic embedded with the web resource 403. By including scripts 413 that are directly executable on the GPU 412, the logic embedded with the web resource 403 can better execute the IGAP 100, as described with various examples.

### CONCLUSION

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature. Thus, the absence of describing combinations should not preclude having rights to such combinations.

Examples Clauses: Various embodiments of the present disclosure are described in the following numbered clauses:
CLAUSE 1. A computer-implemented method for rendering content on a first user device, the method being implemented by one or more processors and comprising: a) rendering content tiles in a first cache, the content tiles representing a segment of a shared content provided on a canvas; b) receiving collaborator change data over one or more networks, the collaborator change data representing a change made to the shared content by a second user device; c) determining which content tiles in the first cache are affected by the collaborator change data; d) for each affected content tile, (i) implementing a time-slicing process to render a replacement content tile; and (ii) after completing rendering of the replacement tile, updating the first cache by replacing the affected content tile with the replacement tile; and e) displaying the segment of the shared content using the updated first cache.
CLAUSE 2. The computer-implemented method of clause 1, wherein updating the first cache includes: re-rendering each affected tile of the collaborator change as a corresponding replacement tile in a second cache, and updating the first cache with the corresponding replacement tile of each affected tile once all of the corresponding replacement tiles are rendered in the second cache.
Clause 3. The computer-implemented method of clause 1 or 2, wherein rendering content tiles in cache is based on a local copy of a shared workspace file; and wherein the method further comprises: updating the local copy of the shared workspace file based on the collaborator change data.
Clause 4: The computer-implemented method of any of clauses 1-3, wherein rendering content tiles in cache includes rendering multiple sets of content tiles, each set of content tile representing a different magnification level for a corresponding portion of the shared content that includes or overlaps with the segment of the shared content.
CLAUSE 5. The computer-implemented method of any of clauses 1-4, wherein a) through e) are performed while first device is performing a navigational viewing operation.
CLAUSE 6. The computer-implemented method of any of clauses 1-5, wherein the navigational viewing operation includes one of a panning operation, an increase magnification operation, or a decrease magnification operation.
CLAUSE 7. The computer-implemented method of claim 1, wherein implementing the time-slicing process includes: for each affected content tile, (i) initiating, during a rendering time interval for a current frame interval, a series of operations to render a replacement content tile in cache for the affected content tile; and (ii) making a determination as to whether the replacement content tile for the affected content tile can be rendered within the rendering time interval of the current frame interval.
CLAUSE 8. The computer-implemented method of any of clauses 1-7, wherein implementing the time-slicing process for at least one of the affected content tiles includes: in response to making the determination that the replacement content tile for the affected content tile cannot be rendered within the rendering time interval of the current frame interval, time-slicing a remainder of the series of operations by: (i) recording a marker that identifies a completed portion of the series of operations, and (ii) pausing performance of the remainder portion of the series of operations for a remainder of the current frame interval.
CLAUSE 9. The computer-implemented method of any of clauses 1-8, wherein implementing the time-slicing process for at least one of the affected content tiles includes: initiating, during a rendering time interval of a following frame interval, the remainder of the series of operations based on the marker, and making a determination as to whether the replacement content tile for the affected content tile can be rendered within the rendering time interval of the following frame interval.
CLAUSE 10. The computer-implemented method of any of clauses 1-9, wherein the operations further comprise: upon completion of the first frame interval, (i) identifying each affected content tile for which rendering of the replacement tile is complete; and (ii) for each affected content tile for which rendering of the replacement tile is complete, evicting the affected tile in place of the rendered replacement tile.
CLAUSE 11. A non-transitory computer-readable medium that stores instructions, which when executed by one or more processors of a computer device, cause the computer device to perform operations for performing methods of any of clauses 1 through 10.
CLAUSE 12. A network computer system comprising: a memory subsystem to store a set of instructions; one or more processors that operate to communicate the set of instructions to a plurality of user devices, wherein the set of instructions include instructions that when executed by each user device of the plurality of user devices, causes the user device to perform operations comprising for performing methods of any of clauses 1 through 10.
CLAUSE 13. A user computing device operable to perform operations for performing methods of any of clauses 1 through 10.

What is claimed is:

1. A computer-implemented method for rendering content on a first user device, the method being implemented by one or more processors and comprising:
a) rendering content tiles in a first cache, the content tiles representing a segment of a shared content provided on a canvas;
b) receiving collaborator change data over one or more networks, the collaborator change data representing a change made to the shared content by a second user device;
c) determining which content tiles in the first cache are affected by the collaborator change data;
d) for each affected content tile, (i) implementing a time-slicing process to render a replacement content tile; and (ii) after completing rendering of the replacement tile, updating the first cache by replacing the affected content tile with the replacement tile; and
e) displaying the segment of the shared content using the updated first cache.

2. The computer-implemented method of claim 1, wherein updating the first cache incudes:
re-rendering each affected tile of the collaborator change as a corresponding replacement tile in a second cache, and updating the first cache with the corresponding replacement tile of each affected tile once all of the corresponding replacement tiles are rendered in the second cache.

3. The computer-implemented method of claim 1, wherein rendering content tiles in cache is based on a local copy of a shared workspace file; and wherein the method further comprises:
updating the local copy of the shared workspace file based on the collaborator change data.

4. The computer-implemented method of claim 1, wherein rendering content tiles in cache includes rendering multiple sets of content tiles, each set of content tile representing a different magnification level for a corresponding portion of the shared content that includes or overlaps with the segment of the shared content.

5. The computer-implemented method of claim 1, wherein a) through e) are performed while first device is performing a navigational viewing operation.

6. The computer-implemented method of claim 5, wherein the navigational viewing operation includes one of a panning operation, an increase magnification operation, or a decrease magnification operation.

7. The computer-implemented method of claim 1, wherein implementing the time-slicing process includes:
for each affected content tile, (i) initiating, during a rendering time interval for a current frame interval, a series of operations to render a replacement content tile in cache for the affected content tile; and (ii) making a determination as to whether the replacement content tile for the affected content tile can be rendered within the rendering time interval of the current frame interval.

8. The computer-implemented method of claim 7, wherein implementing the time-slicing process for at least one of the affected content tiles includes:
in response to making the determination that the replacement content tile for the affected content tile cannot be rendered within the rendering time interval of the current frame interval, time-slicing a remainder of the series of operations by:
(i) recording a marker that identifies a completed portion of the series of operations, and (ii) pausing performance of the remainder portion of the series of operations for a remainder of the current frame interval.

9. The computer-implemented method of claim 8, wherein implementing the time-slicing process for at least one of the affected content tiles includes:
initiating, during a rendering time interval of a following frame interval, the remainder of the series of operations based on the marker, and making a determination as to whether the replacement content tile for the affected content tile can be rendered within the rendering time interval of the following frame interval.

10. The computer-implemented method of claim 7, wherein the operations further comprise:
upon completion of the first frame interval, (i) identifying each affected content tile for which rendering of the replacement tile is complete; and (ii) for each affected content tile for which rendering of the replacement tile is complete, evicting the affected tile in place of the rendered replacement tile.

11. A non-transitory computer-readable medium that stores instructions, which when executed by one or more processors of a computer device, cause the computer device to perform operations for performing method of claim 1.

12. A network computer system comprising:
a memory sub-system to store a set of instructions;
one or more processors that operate to communicate the set of instructions to a plurality of user devices, wherein the set of instructions include instructions that when executed by each user device of the plurality of user devices, causes the user device to perform operations comprising for performing method of claim 1.

13. A user computing device operable to perform operations for performing method of claim 1.
